(19) United States
(12) Patent Application Publication
(10) Pub. No.: US 2020/0019047 A1
(43) Pub. Date: Jan. 16, 2020

(54) PROJECTOR AND OPTICAL ENGINE THEREOF

(71) Applicant: QISDA CORPORATION, Taoyuan City (CN)

(72) Inventors: Chien-Hung Lin, Taoyuan City (TW); Tsung-Hsun Wu, Taoyuan City (TW)

(21) Appl. No.: 16/413,571

(22) Filed: May 15, 2019

(30) Foreign Application Priority Data
Jul. 10, 2018 (CN) 201810752153.X

(51) Int. Cl. G03B 21/14; G02B 5/00; H04N 9/31

(52) U.S. Cl. CPC G03B 21/145; H04N 9/3152; G02B 5/003

(57) ABSTRACT

A projector includes a casing, a controlling module, and an optical engine. The controlling module and the optical engine are disposed in the casing. The controlling module is electrically connected to the optical engine for controlling operation of the optical engine. The optical engine includes a light source, a phosphor wheel, and an airflow generating device. The phosphor wheel has a rotary surface and at least one phosphor region on the rotary surface. The phosphor region can absorb a first light from the light source to emit a second light at a different wavelength. The airflow generating device generates an airflow. The airflow obliquely blows to the rotary surface, so as to dissipate heat from the phosphor wheel.

### BACKGROUND OF THE INVENTION

### 1. Field of the Invention

The present invention relates to a projector, and more particularly to a projector having a phosphor wheel and an optical engine thereof.

### 2. Description of the Prior Art

With the rapid development of technology, the technology of lasers becomes more and more mature. The light source systems of projectors gradually start using laser light as their light sources for projection applications of high brightness. Many projectors using laser light sources use a phosphor wheel to convert laser light into light in different colors as light sources for projecting images. The phosphor wheel also absorbs partial energy when converting laser light, which raises the temperature thereof. However, the temperature of the phosphor wheel will affect the conversion efficiency. The conversion efficiency will become worse due to a higher temperature, so the phosphor wheel needs heat dissipation. Currently laser optical engines use a fan to generate an airflow blowing toward the phosphor wheel for heat dissipation. However, the efficiency of heat dissipation is still limited on the condition that the fan is disposed just toward the phosphor wheel.

### SUMMARY OF THE INVENTION

The present invention provides an optical engine, in which a generated airflow for dissipating heat from a phosphor wheel is configured specifically so as to enhance the efficiency of heat dissipation of the airflow to the phosphor wheel.

An optical engine according to the invention includes a light source, a phosphor wheel, and an airflow generating device. The phosphor wheel has a rotary surface and at least one phosphor region on the rotary surface. The phosphor region absorbs a first light from the light source to emit a second light at a different wavelength. The airflow generating device generates an airflow. The airflow obliquely blows toward the rotary surface. Thereby, the efficiency of heat dissipation of the airflow to the phosphor wheel is improved.

Another objective of the invention is to provide a projector, which includes one like the above-mentioned optical engine, in which a generated airflow for dissipating heat from a phosphor wheel is configured specifically so as to enhance the efficiency of heat dissipation of the airflow to the phosphor wheel.

A projector according to the invention includes a casing, an optical engine, and a controlling module. The optical engine is disposed in the casing. The controlling module is disposed in the casing and electrically connected to the optical engine for controlling operation of the optical engine. The optical engine includes a light source, a phosphor wheel, and an airflow generating device. The phosphor wheel has a rotary surface and at least one phosphor region on the rotary surface. The phosphor region absorbs a first light from the light source to emit a second light at a different wavelength. The airflow generating device generates an airflow. The airflow obliquely blows toward the rotary surface. Thereby, in the optical engine, the efficiency of heat dissipation of the airflow to the phosphor wheel is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a projector according to an embodiment.

FIG. 2 is a schematic diagram illustrating a phosphor wheel of an optical engine of the projector in FIG. 1.

FIG. 3 is a schematic diagram illustrating the disposition of a first airflow generating device of the optical engine in FIG. 1 relative to the phosphor wheel.

FIG. 4 is a side view of the phosphor wheel of the first airflow generating device in FIG. 3.

FIG. 5 is a top view of the phosphor wheel of the first airflow generating device in FIG. 3.

FIG. 6 is a side view of the first airflow generating device in FIG. 4 that is achieved by a fan and an airflow-guiding structure.

FIG. 7 is a top view of a phosphor wheel, a first airflow generating device, and a second airflow generating device of an optical engine according to another embodiment.

FIG. 8 is a side view of the phosphor wheel, the first airflow generating device, and the second airflow generating device in FIG. 7, of which the view point is the same as FIG. 4.

### DETAILED DESCRIPTION

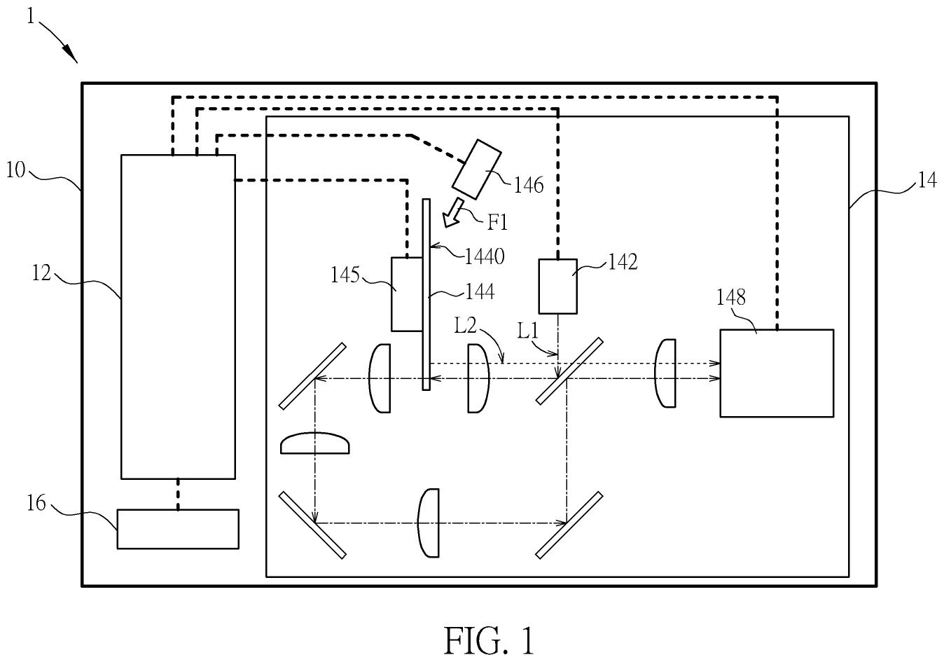

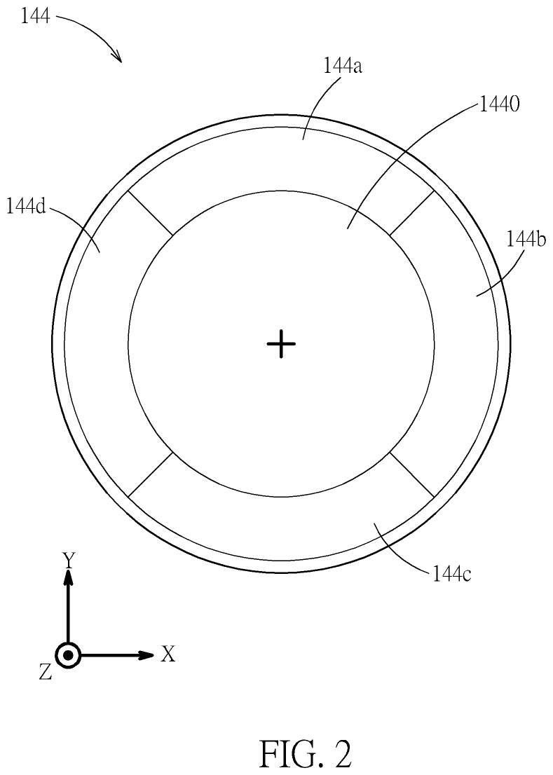

Please refer to FIG. 1 and FIG. 2. A projector 1 according to an embodiment includes a casing 10 (indicated by a bold rectangle in FIG. 1) and a controlling module 12 and an optical engine 14 which are disposed in the casing 10. The controlling module 12 is electrically connected to the optical engine 14 (indicated by bold dashed lines in FIG. 1) for controlling the operation of the optical engine 14. The controlling module 12 usually includes a power supply, a controller and so on, which are usually achieved by circuit board modules connected with each other (therein each circuit board module usually includes a circuit board and a control chip and required electronic components disposed on the circuit board). The optical engine 14 includes a light source 142, a phosphor wheel 144, a first airflow generating device 146, a projection system 148, and a plurality of optical components for guiding light. The light source 142 is controlled by the controlling module 12 to produce a first light L1, e.g. blue laser light. The phosphor wheel 144 has a rotary surface 1440, at least one phosphor region 144a˜c coated on the rotary surface 140, and a transparent region 144d on the rotary surface 140 (as shown by FIG. 2). The phosphor wheel 144 is driven to rotate through a servomotor 145. The servomotor 145 is controlled by the controlling module 12, so that the first light L1 can be projected onto the different regions (i.e. 144a˜d) of the phosphor wheel 144. Each phosphor region 144a˜c can absorb the first light L1 from the light source 142 to emit a second light L2 at a different wavelength. When the light L1 is projected onto the transparent region 144d, the first light L1 penetrates through the phosphor wheel 144 (or is not converted by the phosphor wheel 144), and then is guided to the projection system 148 as a light source for a blue image. Similarly, when the first light L1 is projected onto the phosphor regions 144a˜c, the phosphor regions 144a˜c will emit different second lights L2 according to the fluorescent characteristics of the phosphor regions 144a˜c respectively. The second lights L2 are guided to the projection system 14 as light sources for images of different colors. In practice, a color wheel may be used for further filtering the second light L2 to obtain light of a different color. For example, a yellow light that is converted from phosphor powder can be filtered by a red filter for obtaining red light. Furthermore, in practice, the phosphor wheel 144 can be achieved by but not limited to a transparent glass plate on which phosphor powder of different colors is coated as the phosphor regions 144a˜c. Furthermore, the disposition quantity and distribution central angles of the phosphor regions 144a˜c depend on the specification of the optical engine 14, not limited to the embodiment. In addition, the projector 1 further includes a system fan 16 which is electrically connected to the controlling module 12 for providing airflow passing through the casing 10 to dissipate heat from the components inside the casing 10.

Furthermore, in the embodiment, the first airflow generating device 146 generates a first airflow F1 (indicated by a hollow arrow in FIG. 1) that blows toward the rotary surface 1440 for dissipating heat from the phosphor wheel 144. In addition, the projection system 148 can be achieved by the projection system of a common projector. For example, the projection system 148 includes a digital micromirror device, a projection lens, and other required optical components (e.g. light-guiding tube, reflective mirrors). For another example, the projection system 148 includes at least one liquid crystal panel, a projection lens, and other required optical components (e.g. prisms, reflective mirrors). In addition, in the embodiment, the phosphor wheel 144 is partially used to convert light in a reflection way. The first airflow generating device 146 and the light source 142 are located at the front side of the phosphor wheel 144. However, it is not limited thereto in practice. For example, if the phosphor wheel 144 is provided to convert light in a penetration way, the first airflow generating device 146 and the light source 142 are located at the front side and the rear side of the phosphor wheel 144 respectively in principle.

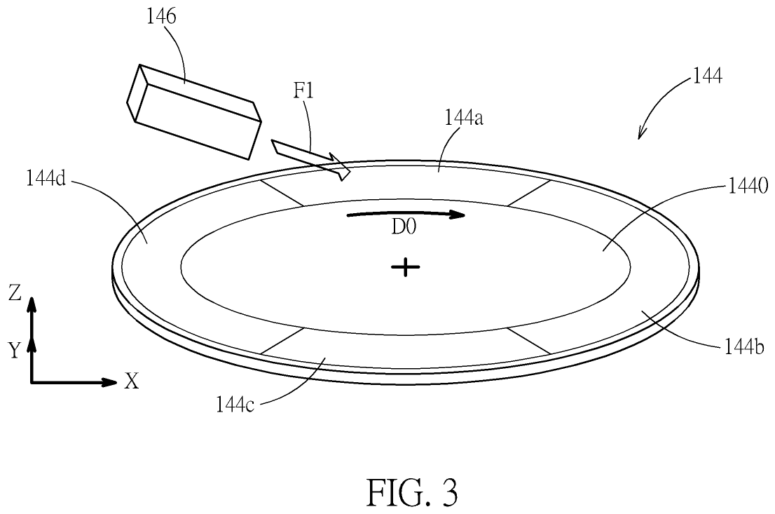

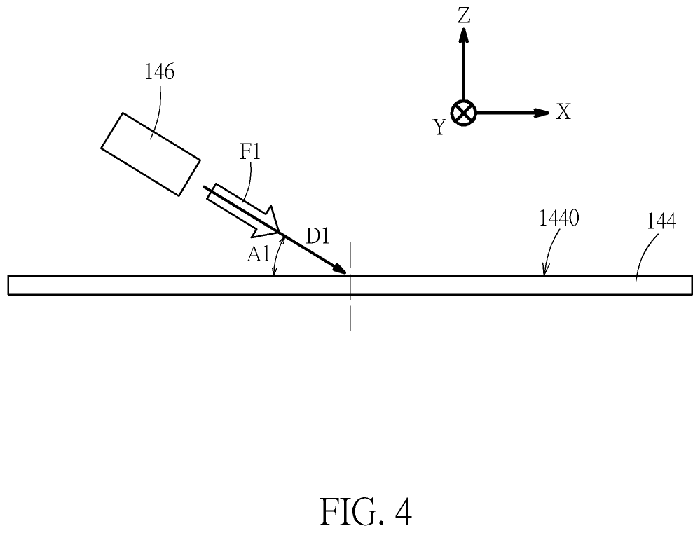

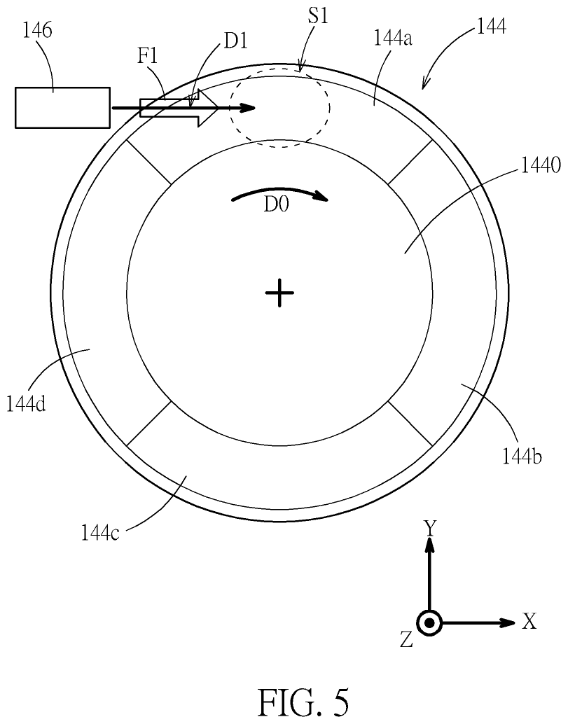

Please also refer to FIG. 3 to FIG. 5; therein, for simplification of drawings, the first airflow generating device 146 is shown by a rectangle in the figures. The rotary surface 1440 rotates in a rotation direction D0 (e.g. clockwise). The rotation axis thereof is indicated by a cross mark in FIG. 2, FIG. 3 and FIG. 5 and by a chain line in FIG. 4. In other words, based on a Cartesian coordinate system, the rotary surface 1440 is parallel to the X-Y plane, and the rotation axis is parallel to the Z axis. The first airflow F1 obliquely blows toward the rotary surface 1440; that is, the flowing direction D1 of the first airflow F1 is not parallel to and not perpendicular to the rotary surface 1440. Thereby, the gas of the first airflow F1 that impacts the rotary surface 1440 will not straightly rebound off the rotary surface 1440, so that the gas substantially will not interfere with the progress toward the rotary surface 1440 of the gas of the first airflow F1 that has not impacted the rotary surface 1440 yet. Hence, the first airflow F1 can touch the rotary surface 1440 efficiently, i.e. dissipating heat from the rotary surface 1440 efficiently.

Furthermore, in the embodiment, as shown by FIG. 4, the flowing direction D1 and the rotary surface 1440 form an included angle A1 therebetween, which is an acute angle, so that the first airflow F1 can dissipate heat from the rotary surface 1440 smoothly and stably. In practice, the included angle A1 can be designed to be within a range from 10 degrees to 80 degrees, for which the first airflow F1 has a heat dissipation effect better than for other angle range. Furthermore, in practice, the included angle A1 can be designed to be or close to 45 degrees, for which the heat dissipation effect is enhanced relatively.

Furthermore, in the embodiment, as shown by FIG. 5, a projection direction of the flowing direction D1 on the rotary surface 1440 points to the same direction as the rotation direction D0. Therein, although the rotation direction D0 is an arced direction, the flowing direction D1 is defined as the direction of the first airflow F1 when the first airflow F1 touches the rotary surface 1440. Therefore, in the embodiment, the projection direction of the flowing direction D1 on the rotary surface 1440 points to the same direction as the rotation direction D0. In another aspect, the projection direction is equal to a tangent direction of the rotation of the rotary surface 1440 there. However, it is not limited thereto in practice. For example, the projection direction and the tangent direction of the rotation of the rotary surface 1440 can form an included angle therebetween. In this case, the first airflow F1 still obliquely blows toward the rotary surface 1440 and can provide a good enough effect of heat dissipation to the rotary surface 1440.

Furthermore, in the embodiment, as shown by FIG. 5, the contact area S1 (indicated by a dashed ellipse in the figure) where the first airflow F1 directly impacts the rotary surface 1440 overlaps the regions 144a˜d. In other words, the first airflow F1 can touch the phosphor regions 144a˜c. In general, for the structure of the phosphor wheel 144, the phosphor regions 144a˜c convert the first light L1, so the phosphor regions 144a˜c absorb heat from the first light L1 resulting in a higher temperature. In the embodiment, the regions 144a˜d are partially touched by the first airflow F1, so that heat from the phosphor wheel 144 can be efficiently dissipated. Furthermore, the contact area S1 covers the whole phosphor regions 144a˜c in the radial direction of the rotation of the phosphor wheel 144. However, it is not limited thereto.

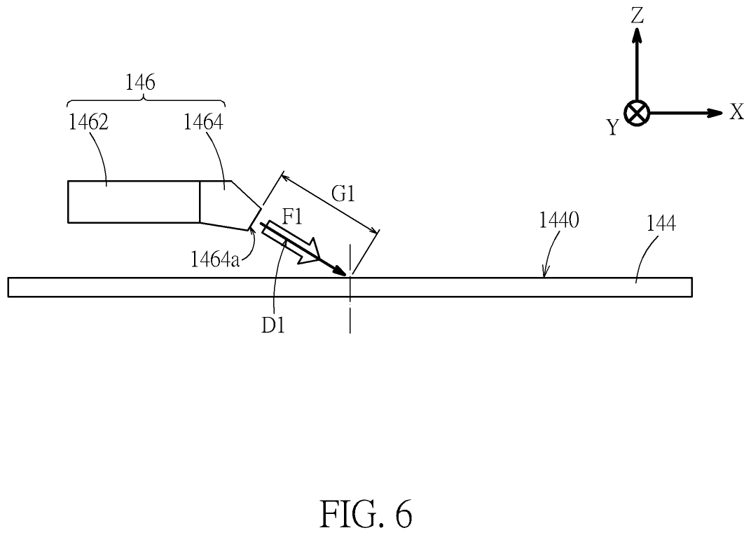

In practice, the first airflow generating device 146 can use an axial-flow fan or a centrifugal fan to generate the first airflow F1. Please also refer to FIG. 6. The first airflow generating device 146 is achieved by a fan 1462 and an airflow-guiding structure 1464. In practice, the airflow-guiding structure 1464 can be provided by another structural part that is structurally engaged to the fan 1462, or the airflow-guiding structure 1464 and the fan 1462 are structurally integrated (that is, the airflow-guiding structure 1464 is provided by a partial structure of the fan 1462). In FIG. 6, for simplification of illustration, the fan 1462 and the airflow-guiding structure 1464 are shown by two figures. In practice, the fan 1462 can be achieved by but not limited to an axial-flow fan or a centrifugal fan. As shown by FIG. 6, the airflow-guiding structure 1464 has an airflow-guiding structural opening 1464a. The airflow generated by the fan 1462 is guided by the airflow-guiding structure 1464 to blow out through the airflow-guiding structural opening 1464a, so as to form the first airflow F1. The first airflow F1 blows from the airflow-guiding structural opening 1464a toward the rotary surface 1440 in the flowing direction D1. For actual applications, a distance G1 between the airflow-guiding structural opening 1464a and the rotary surface 1440 in the flowing direction D1 can be larger than or equal to 20 mm, for preventing the static pressure at the airflow-guiding structural opening 1464a from being too high to obstruct the movement of the first airflow F1.

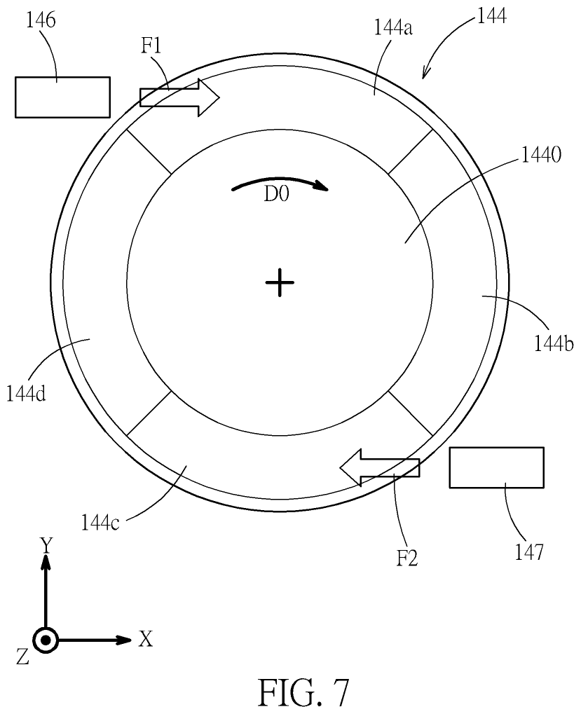

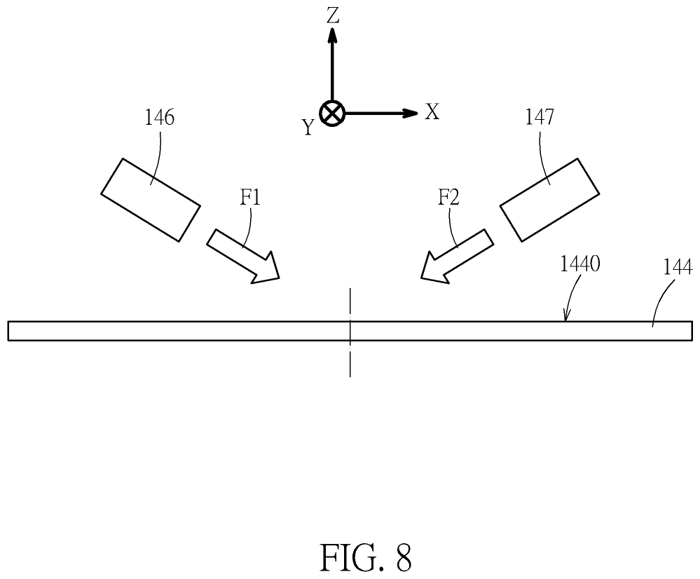

In the above embodiment, the optical engine 14 uses an airflow generating device 146 to dissipate heat from the phosphor wheel 144; however, it is not limited thereto in practice. For an embodiment, the optical engine thereof is equivalent to the above-mentioned optical engine 14 and further includes a second airflow generating device 147 that works together with the first airflow generating device 146 for dissipating heat from phosphor wheel 144. For other descriptions about the optical engine of the embodiment, please refer to the relevant descriptions of the optical engine 14, which will not be described in addition. Furthermore, the optical engine of the embodiment can replace the optical engine 14 to be used in the projector 1, which will not be described in addition. In the embodiment, the disposition of the first airflow generating device 146 and the second airflow generating device 147 relative to the phosphor wheel 144 is shown by FIG. 7 and FIG. 8. For simplification of description, the structure of the second airflow generating device 147, variations thereof, and the relative position of the second airflow generating device 147 to other components are the same as the first airflow generating device 146; however, it is not limited thereto in practice. As shown by FIG. 7 and FIG. 8, the first airflow generating device 146 and the second airflow generating device 147 are located at two opposite sides of the phosphor wheel 144 (as shown by FIG. 7) relative the rotation axis of the phosphor wheel 144 (indicated by a cross mark in FIG. 7 and by a chain line in FIG. 8). The second airflow generating device 147 generates a second airflow F2 (indicated by a hollow arrow in the figures). The second airflow F2 obliquely blows toward the rotary surface 1440 (as shown by FIG. 8). Therein, the relationship between the second airflow F2 and the phosphor wheel 144 is the same as that between the first airflow F1 and the phosphor wheel 144, which will not be described in addition. However, it is not limited thereto in practice. For example, the second airflow F2 obliquely blows toward the rotary surface 1440 in a different flowing direction.

Furthermore, in the embodiment, the first airflow generating device 146 and the second airflow generating device 147 are oppositely disposed relative to the phosphor wheel 144; however, it is not limited thereto in practice. For example, the first airflow generating device 146, the second airflow generating device 147, and the light source are disposed at equal central angles (i.e. 120 degrees) relative to the rotation axis, or the first airflow generating device 146 and the second airflow generating device 147 are disposed arbitrarily at the periphery of the phosphor wheel 144. Furthermore, in practice, the phosphor wheel 144 can use more airflow generating devices for dissipating heat. These airflow generating devices also can be disposed but not limited to at equal central angles relative to the rotation axis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical engine, comprising:
a light source;
a phosphor wheel, having a rotary surface and at least one phosphor region on the rotary surface, the phosphor region absorbing a first light from the light source to emit a second light at a different wavelength; and
a first airflow generating device, generating a first airflow, the first airflow obliquely blowing toward the rotary surface.

2. The optical engine according to claim 1, wherein the first airflow blows toward the rotary surface in a flowing direction, and the flowing direction and the rotary surface form an included angle within a range from 10 degrees to 80 degrees.

3. The optical engine according to claim 2, wherein the included angle is 45 degrees.

4. The optical engine according to claim 1, wherein the rotary surface rotates in a rotation direction, the first airflow blows toward the rotary surface in a flowing direction, and the rotation direction and the flowing direction form an acute angle.

5. The optical engine according to claim 1, wherein the rotary surface rotates in a rotation direction, the first airflow blows toward the rotary surface in a flowing direction, a projection direction of the flowing direction on the rotary surface points to the same direction as the rotation direction.

6. The optical engine according to claim 1, wherein the first airflow touches the at least one phosphor region.

7. The optical engine according to claim 1, wherein the first airflow generating device comprises a fan and an airflow-guiding structural opening, the first airflow blows from the airflow-guiding structural opening toward the rotary surface in a flowing direction, and a distance between the airflow-guiding structural opening and the rotary surface in the flowing direction is larger than or equal to 20 mm.

8. The optical engine according to claim 1, further comprising a second airflow generating device, wherein the first airflow generating device and the second airflow generating device are located at two opposite sides of the phosphor wheel, the second airflow generating device generates a second airflow, and the second airflow obliquely blows toward the rotary surface.

9. The optical engine according to claim 1, wherein the first airflow generating device comprises an axial-flow fan or a centrifugal fan.

10. A projector, comprising:
a casing;
an optical engine, disposed in the casing, the optical engine comprising:
a light source;
a phosphor wheel, having a rotary surface and at least one phosphor region on the rotary surface, the phosphor region absorbing a first light from the light source to emit a second light at a different wavelength; and
a first airflow generating device, generating a first airflow, the first airflow obliquely blowing toward the rotary surface; and
a controlling module, disposed in the casing and electrically connected to the optical engine for controlling operation of the optical engine.

11. The projector according to claim 10, wherein the first airflow blows toward the rotary surface in a flowing direction, and the flowing direction and the rotary surface form an included angle within a range from 10 degrees to 80 degrees.

12. The projector according to claim 11, wherein the included angle is 45 degrees.

13. The projector according to claim 10, wherein the rotary surface rotates in a rotation direction, the first airflow blows toward the rotary surface in a flowing direction, and the rotation direction and the flowing direction form an acute angle.

14. The projector according to claim 10, wherein the rotary surface rotates in a rotation direction, the first airflow blows toward the rotary surface in a flowing direction, a projection direction of the flowing direction on the rotary surface points to the same direction as the rotation direction.

15. The projector according to claim 10, wherein the first airflow touches the at least one phosphor region.

16. The projector according to claim 10, wherein the first airflow generating device comprises a fan and an airflow-guiding structural opening, the first airflow blows from the airflow-guiding structural opening toward the rotary surface in a flowing direction, and a distance between the airflow-guiding structural opening and the rotary surface in the flowing direction is larger than or equal to 20 mm.

17. The projector according to claim 10, wherein the optical engine further comprises a second airflow generating device, the first airflow generating device and the second airflow generating device are located at two opposite sides of the phosphor wheel, the second airflow generating device generates a second airflow, and the second airflow obliquely blows toward the rotary surface.

18. The projector according to claim 10, wherein the first airflow generating device comprises an axial-flow fan or a centrifugal fan.
